(19) United States
(12) Patent Application Publication
(10) Pub. No.: US 2016/0117349 A1
(43) Pub. Date: Apr. 28, 2016

(54) COLLECTIVE RECONCILIATION

(71) Applicant: Google Inc., Mountain View, CA (US)

(72) Inventor: Suresh Toby Segaran, San Francisco, CA (US)

(73) Assignee: GOOGLE INC., Mountain View, CA (US)

(21) Appl. No.: 13/786,170

(22) Filed: Mar. 5, 2013

(51) Int. Cl. G06F 17/30

(52) U.S. Cl. CPC G06F 17/30289

(57) ABSTRACT

Methods, systems, and computer-readable media are provided for collective reconciliation. In some implementations, an collective reconciliation module may remove duplicate entries from merged data a source. The collective reconciliation module may identify a first entity reference in a first data source and may identify one or more entity references in a second data source based on an identifier match. The collective reconciliation module may generate a set of pairings defined by the first entity reference with each of a subset of the one or more entity references based on an iterative analysis of common attributes for the set of pairings. The collective reconciliation module may determine whether a commonality exists for each of the set of pairings. The collective reconciliation module may merge the first data source and the second data source, wherein duplications are identified based at least in part on the determination.

### BACKGROUND

This disclosure generally relates to merging data sources. Multiple data sources, such as databases, can be combined to form a single, merged data source. Some merged data sources may contain duplicate pieces of information. Removal of duplicate entries from a merged data source involves significant manual effort.

### SUMMARY

A first data source may include pieces of information that are partially duplicated in a second data source. It may be desirable to create a merged or combined data source with the duplicates removed. In some implementations, potential duplicate pairings are identified between the two data sources. A commonality metric indicating the strength of the pairing is maintained for each respective pairing. The commonality metric is determined and modified through an iterative binning process. In the first step of the process, the binning criterion is the identifier of the node. In each subsequent step of the binning process, information from other nodes connected to one of the potential pairings is added to the binning criterion, thus reducing the number of potential pairings in that bin. The commonality metric for each potential pairing is increased as the number of potential pairings meeting the criteria for a bin decreases. Duplicate data is identified, for example, when the commonality metric is high.

In some implementations, a computer-implemented method includes identifying a first entity reference in a first data source, the first data source comprising nodes representing entities and comprising edges that define relationships between the nodes. The method includes identifying one or more entity reference in a second data source, the second data source comprising nodes representing entities and edges that define relationships between the nodes, wherein the one or more entity reference corresponds to the first entity reference based on an identifier match. The method includes generating a set of pairings defined by the first entity reference with each of a subset of the one or more entity references based on an iterative analysis of common attributes for the set of pairings, wherein the iterative analysis comprises increasing a number of common attributes used to define the set of pairings for each respective iteration, wherein each subsequent iteration generates a reduced set of pairings. The method includes determining whether a commonality exists for each of the set of pairings. The method includes merging the first data source and the second data source, wherein duplications are identified based at least in part on the determination. Other implementations of this aspect include corresponding systems and computer programs, configured to perform the actions of the methods, encoded on computer storage devices.

These and other implementations can each include one or more of the following features. In some implementations, generating the set of pairings comprises determining a degree of commonality based on a number of entities in the second data source that correspond to the first entity based on the identifier match. In some implementations, the method includes maintaining a metric corresponding to each respective pairing of the set of pairings. In some implementations, the method includes increasing or decreasing the metric for at least one pairing of the set of pairings based on a number of pairing in the set of pairings. In some implementations, the method includes removing duplications from the merged data. In some implementations, determining whether a commonality exists comprises the determining based on the metric. In some implementations, the computer comprises two or more distributed computers. In some implementations, the identifier match represents the first entity and the second entity having the same or similar name.

One or more of the implementations of the subject matter described herein may provide one or more of the following advantages. In some implementations, data sources are merged automatically with high accuracy and precision in removing duplicates. In some implementations, collective reconciliation allows for automated removal of duplicates using distributed computing.

### BRIEF DESCRIPTION OF THE FIGURES

FIG. 1 is a block diagram showing illustrative data sources being merged using collective reconciliation to form a merged data source in accordance with some implementations of the present disclosure;

FIG. 2 shows an illustrative data graph containing nodes and edges in accordance with some implementations of the present disclosure;

FIG. 3 shows an illustrative knowledge graph portion in accordance with some implementations of the present disclosure;

FIG. 4 shows another illustrative knowledge graph portion in accordance with some implementations of the present disclosure;

FIG. 5 shows an illustrative first and second data source that may be merged using collective reconciliation in accordance with some implementations of the present disclosure;

FIG. 6 illustrates an iterative binning process used in collective reconciliation in accordance with some implementations of the present disclosure;

FIG. 7 shows a flow diagram including illustrative steps for merging data sources using collective reconciliation in accordance with some implementations of the present disclosure;

FIG. 8 shows an illustrative computer system that may be used to implement collective reconciliation in accordance with some implementations of the present disclosure; and

FIG. 9 is a block diagram of a computer in accordance with some implementations of the present disclosure.

### DETAILED DESCRIPTION OF THE FIGURES

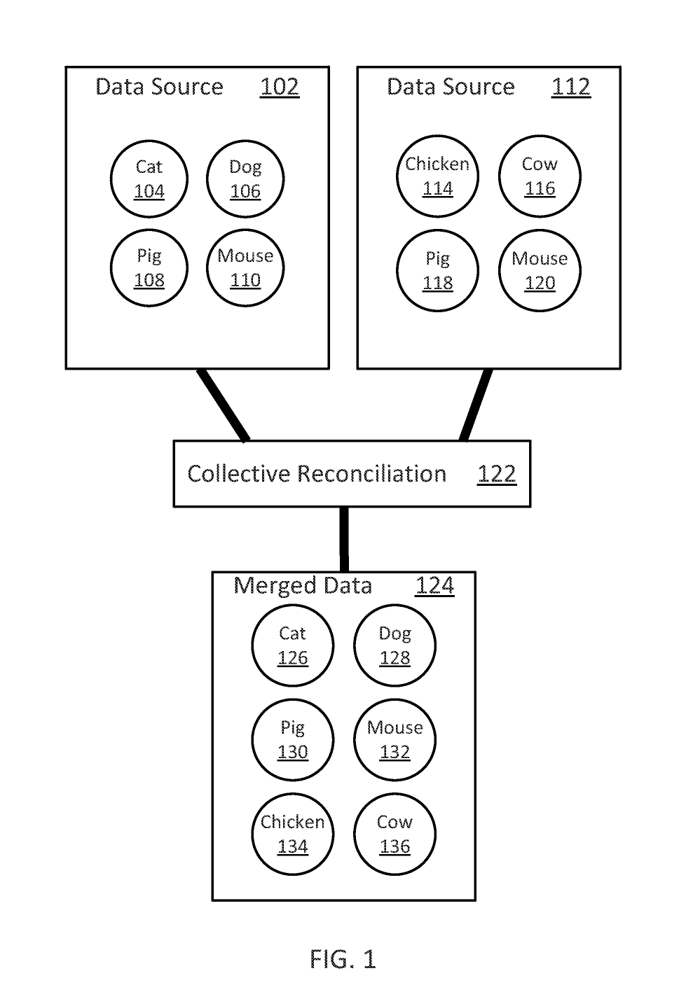

FIG. 1 is a block diagram showing illustrative data sources being merged using collective reconciliation to form a merged data source in accordance with some implementations of the present disclosure. The collective reconciliation step removes duplicates from the merged data.

First data source 102 and second data source 112 include pieces of information illustrated as circles. Data source 102 includes the pieces of information “Cat” 104, “Dog” 106, “Pig” 108, and “Mouse” 110. Data source 112 includes the pieces of information “Chicken” 114, “Cow” 116, “Pig” 118, and “Mouse” 120. It may be desirable to create a merged data source with the duplicates removed. In an example, data source 102 is a list of animals kept as pets, data source 112 is a list of animals found on a farm, and merged data source 124 is a combined list of animals.

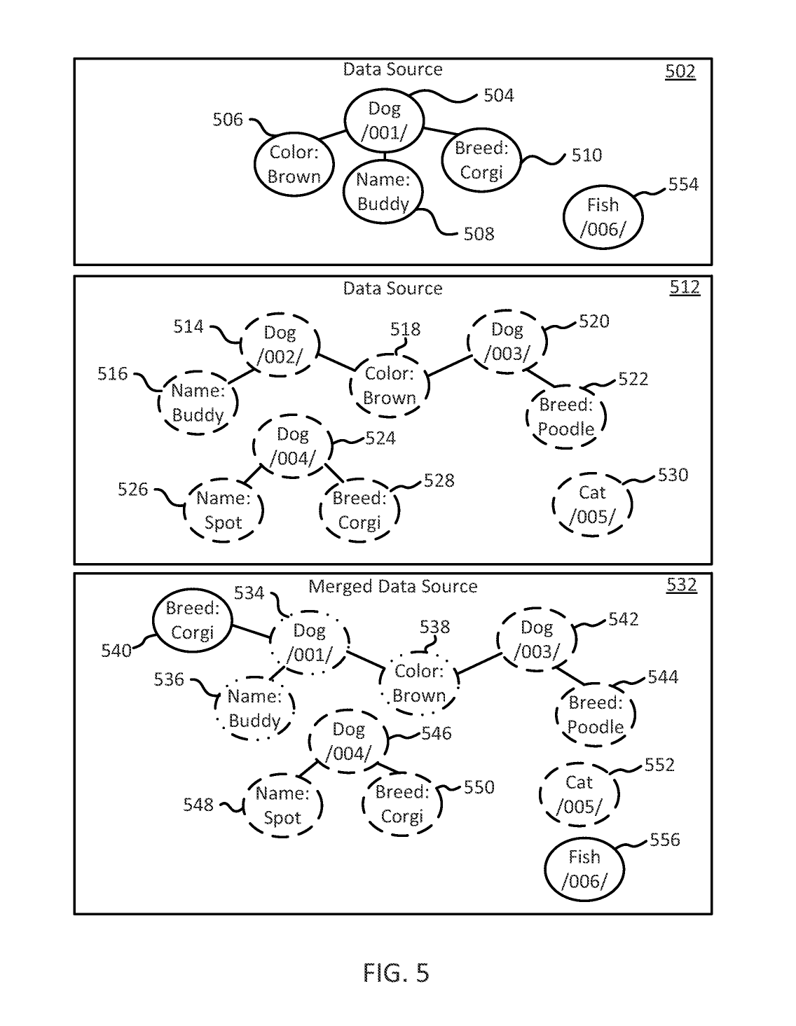

In an implementation, a collective reconciliation module 122 combines data source 102 and data source 112 and removes duplicate pieces of information. Collective reconciliation module 122 will be described in more detail below with relation to FIGS. 5-7. Collective reconciliation module 122 includes any suitable hardware, software, or combination thereof for implementing the data reconciliation features as described herein. It will be understood that in some implementations, collective reconciliation module 122 may merge the data sources and remove the duplications, while in some implementations, a previously merged data source including duplicates is input to collective reconciliation module 122 to remove the duplicates.

Collective reconciliation module 122 outputs merged data source 124. As illustrated, merged data source 124 includes “Cat” 126, “Dog” 128, “Pig” 130, “Mouse,” 132, “Chicken” 134, and “Cow” 136. In some implementations, “Cat” 126 corresponds to “Cat” 104 of data source 102. In some implementations, “Dog” 128 corresponds to “Dog” 106 of data source 102. In some implementations, “Pig” 130 corresponds to both “Pig” 108 of data source 102 and “Pig” 118 of data source 112. Collective reconciliation module 122 may determine that “Pig” 108 and “Pig” 118 would be duplicate entries in the merged data, and remove the duplication. In some implementations, “Mouse” 132 corresponds to both “Mouse” 110 of data source 102 and “Mouse” 120 of data source 112, where the duplication has been removed by collective reconciliation module 122. In some implementations, “Chicken” 134 corresponds to “Chicken” 114 of data source 112. In some implementations, “Cow” 136 corresponds to “Cow” 116 of data source 112.

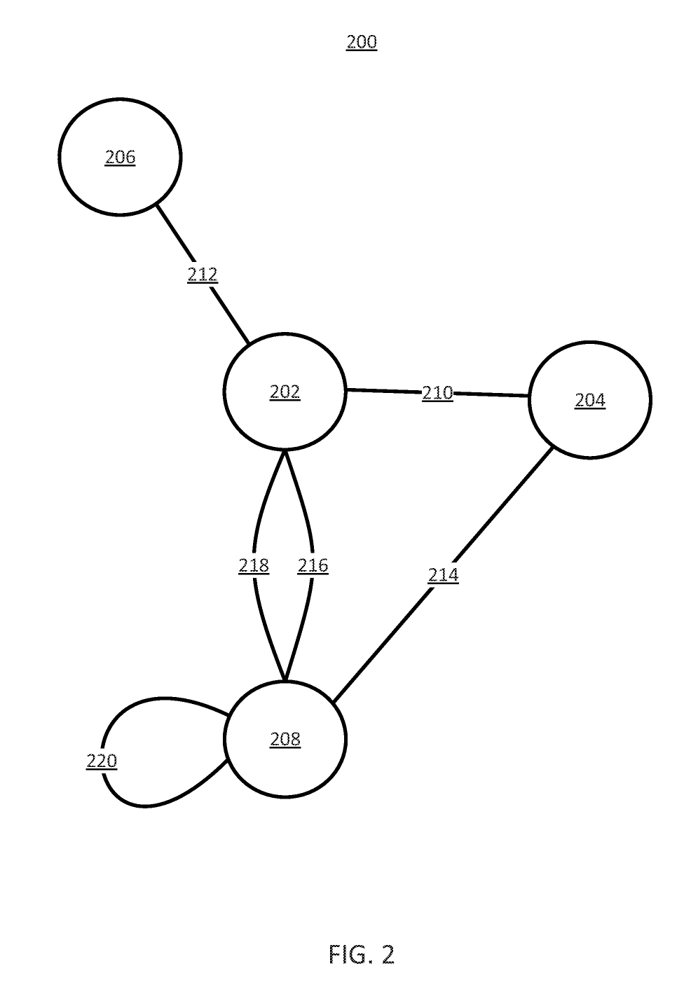

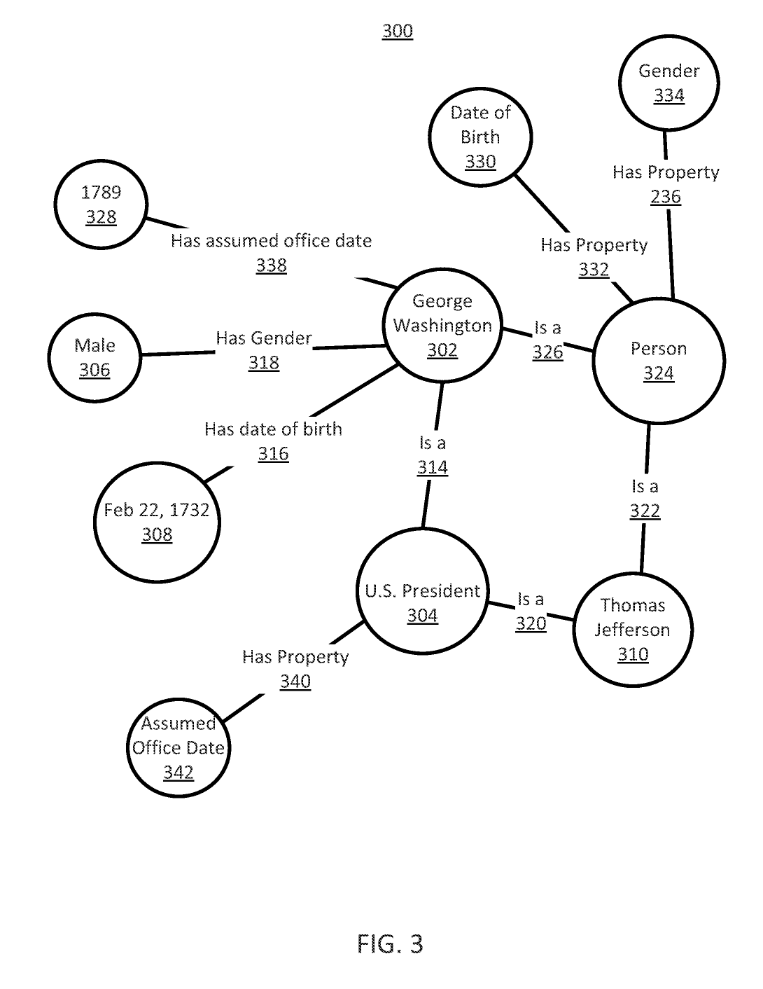

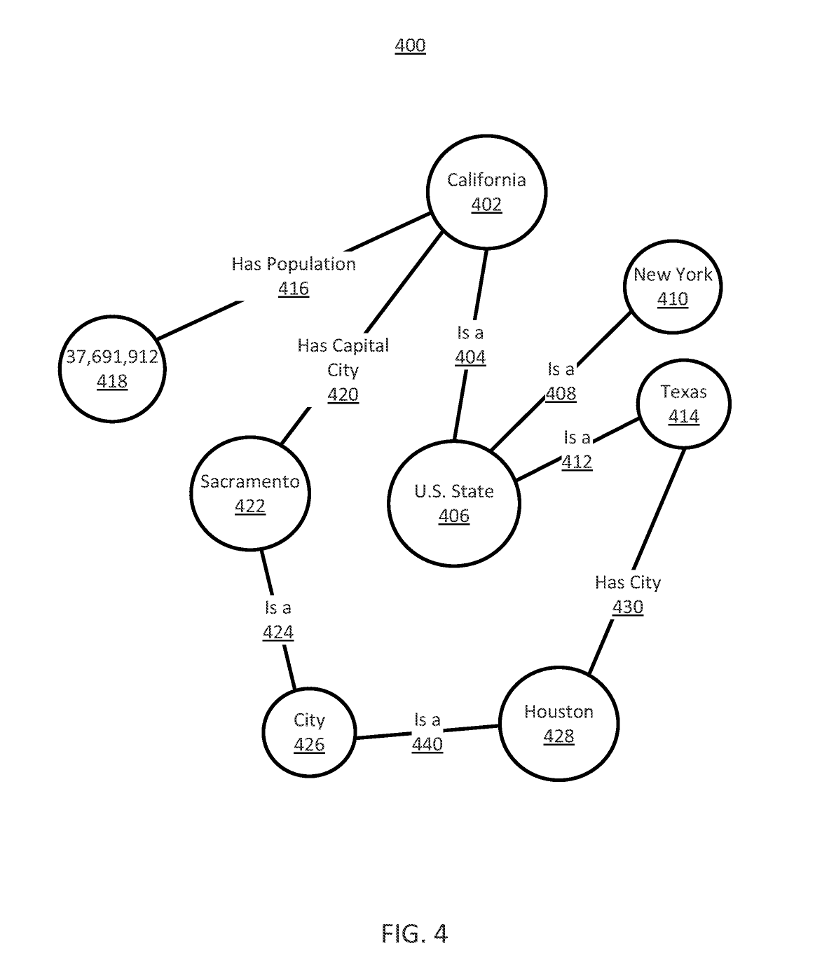

FIG. 2 shows an illustrative data graph containing nodes and edges in accordance with some implementations of the present disclosure. In some implementations, illustrative data graph 200 is a portion of a knowledge graph. The knowledge graph will be described in further detail in relation to FIGS. 3 and 4 below. It will be understood that the data graph implementation of FIG. 2, and in particular the knowledge graph, is merely an example of a data structure that may be used by the collective reconciliation module or any other suitable hardware, software, or combination thereof, and that any suitable data structure or data format may be used. Data stored by the data structure may include any suitable data such as references to data, text, images, characters, computer files, databases, any other suitable data, or any combination thereof. It will be understood that in some implementations, the node and edge description is merely illustrative and that the construction of the data structure may include any suitable technique for describing information and relationships. In an example, nodes may be assigned a unique identification number, and an edge may be described using the identification numbers that a particular edge connects. It will be understood that the representation of data as a graph is merely exemplary and that data may be stored, for example, as a computer file including pieces of data and links and/or references to other pieces of data.

In some implementations, data may be organized in a database using any one or more data structuring techniques. For example, data may be organized in a graph containing nodes connected by edges. In some implementations, the data may include statements about relationships between things and concepts, and those statements may be represented as nodes and edges of a graph. The nodes each contain a piece or pieces of data and the edges represent relationships between the data contained in the nodes that the edges connect. In some implementations, the graph includes one or more pairs of nodes connected by an edge. In some implementations, the edge, and thus the graph, may be directed, undirected, or both. In an example, directed edges form a unidirectional connection. In an example, undirected edges form bidirectional connections. In an example, a combination of both directed and undirected edges may be included in the same graph. Nodes may include any suitable data or data representation. Edges may describe any suitable relationships between the data. In some implementations, an edge is labeled or annotated, such that it includes both the connection between the nodes, and descriptive information about that connection. It will be understood that in some implementations, edges between data sources need not be labeled. A particular node may be connected by distinct edges to one or more other nodes, or to itself, such that an extended graph is formed.

In some implementations, the grouping of an edge and two nodes is referred to as a triple. The triple represents the relationship between the nodes, or in some implementations, between the node and itself. In some implementations, higher order relationships are modeled, such as quaternary and n-ary relationships, where n is an integer greater than 2. In some implementations, information modeling the relationship is stored in a node, which may be referred to as a mediator node. In an example, the information “Person X Donates Artifact Y To Museum Z” is stored in a mediator node connected entity nodes to X, Y, and Z, where each edge identifies the role of each respective connected entity node.

Illustrative graph 200 includes nodes 202, 204, 206, and 208. Data graph 200 includes edge 210 connecting node 202 and node 204. Data graph 200 includes edge 212 connecting node 202 and node 206. Data graph 200 includes edge 214 connecting node 204 and node 208. Data graph 200 includes edge 216 and edge 218 connecting node 202 and node 208. Data graph 200 includes edge 220 connecting node 208 to itself. Each aforementioned group of an edge and one or two distinct nodes may be referred to as a triple or 3-tuple. As illustrated, node 202 is directly connected by edges to three other nodes, while nodes 204 and 208 are directly connected by edges to two other nodes. Node 206 is connected by an edge to only one other node, and in some implementations, node 206 is referred to as a terminal node. As illustrated, nodes 202 and 208 are connected by two edges, indicating that the relationship between the nodes is defined by more than one property. As illustrated, node 208 is connected by edge 220 to itself, indicating that a node may relate to itself. While illustrative data graph 200 contains edges that are not labeled as directional, it will be understood that each edge may be unidirectional or bidirectional. It will be understood that this example of a graph is merely an example and that any suitable size or arrangement of nodes and edges may be employed.

FIG. 3 shows illustrative knowledge graph portion 300 in accordance with some implementations of the present disclosure. A knowledge graph is a particular implementation of a data graph as illustrated above in relation to data graph 200 of FIG. 2.

In some implementations, a node of a knowledge graph represents an entity. An entity is a thing or concept that is singular, unique, well-defined and distinguishable. For example, an entity may be a person, place, item, idea, abstract concept, concrete element, other suitable thing, or any combination thereof. It will be understood that in some implementations, the data graph contains an entity reference, and not the physical embodiment of the entity. For example, an entity may be the physical embodiment of George Washington, while an entity reference is an abstract concept that refers to George Washington. In another example, the entity “New York City” refers to the physical city, and the data graph uses a concept of the physical city as represented by, for example, an element in a data structure, the name of the entity, any other suitable element, or any combination thereof. Where appropriate, based on context, it will be understood that the term entity as used herein may correspond to an entity reference, and the term entity reference as used herein may correspond to an entity.

Generally, entities include things or concepts represented linguistically by nouns. For example, the color [Blue], the city [San Francisco], and the imaginary animal [Unicorn] may each be entities. An entity reference generally refers to the concept of the entity. For example, the entity reference [New York City] refers to the physical city, and the data graph uses a concept of the physical city as represented by, for example, an element in a data structure, the name of the entity, any other suitable element, or any combination thereof.

In some implementations, a node representing organizational data may be included in a knowledge graph. These may be referred to herein as entity type nodes. As used herein, an entity type node may refer to a node in a knowledge graph, while an entity type may refer to the concept represented by an entity type node. An entity type may be a defining characteristic of an entity. For example, entity type node Y may be connected to an entity node X by an [Is A] edge or link, discussed further below, such that the graph represents the information “The Entity X Is Type Y.” For example, the entity node [George Washington] may be connected to the entity type node [President]. An entity node may be connected to multiple entity type nodes, for example, [George Washington] may also be connected to entity type node [Person] and to entity type node [Military Commander]. In another example, the entity type node [City] may be connected to entity nodes [New York City] and [San Francisco]. In another example, the concept [Tall People], although incompletely defined, i.e., it does not necessarily include a definition of the property [tall], may exist as an entity type node. In some implementations, the presence of the entity type node [Tall People], and other entity type nodes, may be based on user interaction.

In some implementations, an entity type node may include or be connected to data about: a list of properties associated with that entity type node, the domain to which that entity type node belongs, descriptions, values, any other suitable information, or any combination thereof. A domain refers to a collection of related entity types. For example, the domain [Film] may include, for example, the entity types [Actor], [Director], [Filming Location], [Movie], any other suitable entity type, or any combination thereof. In some implementations, entities are associated with types in more than one domain. For example, the entity node [Benjamin Franklin] may be connected with the entity type node [Politician] in the domain [Government] as well as the entity type node [Inventor] in the domain [Business].

In some implementations, a node may include or connect to data defining one or more attributes. These may be referred to as attribute references and/or properties. The attribute references may define a particular characteristic of the node. The particular attribute references of a node may depend on what the node represents. In some implementations, an entity reference node may include or connect to: attribute references describing the entity reference, a unique identification reference, a list of entity types associated with the node, a list of differentiation aliases for the node, data associated with the entity reference, a textual description of the entity reference, links to a textual description of the entity reference, other suitable information, or any combination thereof. As described above, nodes may contain a reference or link to long text strings and other information stored in one or more documents external to the data graph. In some implementations, the storage technique may depend on the particular information. For example, a unique identification reference may be stored within the node, a short information string may be stored in a terminal node as a literal, and a long description of an entity may be stored in an external document linked to by a reference in the data graph.

Specific values, in some implementations referred to as literals, may be associated with a particular entity in a terminal node by an edge defining the relationship. Literals may refer to values and/or strings of information. For example, literals may include dates, names, and/or numbers. In an example, the entity node [San Francisco] may be connected to a terminal node containing the literal [813000] by an edge annotated with the property [Has Population]. In some implementations, terminal nodes may contain a reference or link to long text strings and other information stored in one or more documents external to the knowledge graph. In some implementations, literals are stored as nodes in the knowledge graph. In some implementations, literals are stored in the knowledge graph but are not assigned a unique identification reference as described below, and are not capable of being associated with multiple entities. In some implementations, literal type nodes may define a type of literal, for example [Date/Time], [Number], or [GPS Coordinates].

In some implementations, nodes and edges define the relationship between an entity type node and its properties, thus defining a schema. For example, an edge may connect an entity type node to a node associated with a property, which may be referred to as a property node. Entities of the type may be connected to nodes defining particular values of those properties. For example, the entity type node [Person] may be connected to property node [Date of Birth] and a node [Height]. Further, the node [Date of Birth] may be connected to the literal type node [Date/Time], indicating that literals associated with [Date of Birth] include date/time information. The entity node [George Washington], which is connected to entity type node [Person] by an [Is A] edge, may also be connected to a literal [Feb. 22, 1732] by the edge [Has Date Of Birth]. In some implementations, the entity node [George Washington] is connected to a [Date Of Birth] property node. It will be understood that in some implementations, both schema and data are modeled and stored in a knowledge graph using the same technique. In this way, both schema and data can be accessed by the same search techniques. In some implementations, schemas are stored in a separate table, graph, list, other data structure, or any combination thereof. It will also be understood that properties may be modeled by nodes, edges, literals, any other suitable data, or any combination thereof.

For example, the entity node [George Washington] may be connected by an [Is A] edge to the entity type node representing [Person], thus indicating an entity type of the entity, and may also be connected to a literal [Feb. 22, 1732] by the edge [Has Date Of Birth], thus defining a property of the entity. In this way, the knowledge graph defines both entity types and properties associated with a particular entity by connecting to other nodes. In some implementations, [Feb. 22, 1732] may be a node, such that it is connected to other events occurring on that date. In some implementations, the date may be further connected to a year node, a month node, and a day of node. It will be understood that this information may be stored in any suitable combination of literals, nodes, terminal nodes, interconnected entities, any other suitable arrangement, or any combination thereof.

In some implementations, entity types, properties, and other suitable content is created, defined, redefined, altered, or otherwise generated by any suitable technique. For example, content may be generated by manual user input, by automatic responses to user interactions, by importation of data from external sources, by any other suitable technique, or any combination thereof. For example, if a commonly searched for term is not represented in the knowledge graph, one or more nodes representing that node may be added. In another example, a user may manually add information and organizational structures.

In some implementations, the knowledge graph may include information for differentiation and disambiguation of terms and/or entities. As used herein, differentiation refers to the many-to-one situation where multiple names are associated with a single entity. As used herein, disambiguation refers to the one-to-many situation where the same name is associated with multiple entities. In some implementations, nodes may be assigned a unique identification reference. In some implementations, the unique identification reference may be an alphanumeric string, a name, a number, a binary code, any other suitable identifier, or any combination thereof. The unique identification reference may allow the system to assign unique references to nodes with the same or similar textual identifiers. In some implementations, the unique identifiers and other techniques are used in differentiation, disambiguation, or both. For example, there may be an entity reference node related to the city [Philadelphia], an entity reference node related to the movie [Philadelphia], and an entity reference node related to the cream cheese brand [Philadelphia]. Each of these nodes may have a unique identification reference, stored for example as a number, for disambiguation within the data graph. In some implementations, disambiguation in the data graph is provided by the connections and relationships between multiple nodes. For example, the city [New York] may be disambiguated from the state [New York] because the city is connected to an entity type [City] and the state is connected to an entity type [State]. It will be understood that more complex relationships may also define and disambiguate nodes. For example, a node may be defined by associated entity types, by other entity references connected to it by particular properties, by its name, by any other suitable information, or any combination thereof. These connections may be useful in disambiguating, for example, the node [Georgia] that is connected to the node [United States] may be understood represent the U.S. State, while the node [Georgia] connected to the nodes [Asia] and [Eastern Europe] may be understood to represent the country in eastern Europe.

Knowledge graph portion 300 includes information related to the entity [George Washington], represented by [George Washington] node 302. [George Washington] node 302 is connected to [U.S. President] entity type node 304 by [Is A] edge 314 with the semantic content [Is A], such that the 3-tuple defined by nodes 302 and 304 and the edge 314 contains the information “George Washington is a U.S. President.” Similarly, “Thomas Jefferson Is A U.S. President” is represented by the tuple of [Thomas Jefferson] node 310, [Is A] edge 320, and [U.S. President] node 304. Knowledge graph portion 300 includes entity type nodes [Person] 324, and [U.S. President] node 304. The person type is defined in part by the connections from [Person] node 324. For example, the type [Person] is defined as having the property [Date Of Birth] by node 330 and edge 332, and is defined as having the property [Gender] by node 334 and edge 336. These relationships define in part a schema associated with the entity type [Person].

[George Washington] node 302 is shown in knowledge graph portion 300 to be of the entity types [Person] and [U.S. President], and thus is connected to nodes containing values associated with those types. For example, [George Washington] node 302 is connected by [Has Gender] edge 318 to [Male] node 306, thus indicating that “George Washington has gender Male.” Further, [Male] node 306 may be connected to the [Gender] node 334 indicating that “Male Is A Type Of Gender.” Similarly, [George Washington] node 302 is connected by [Has Date of Birth] edge 316 to [Feb. 22, 1732] node 308, thus indicating that “George Washington Has Date Of Birth Feb. 22, 1732.” [George Washington] node 302 may also be connected to [1789] node 328 by [Has Assumed Office Date] edge 338.

Knowledge graph portion 300 also includes [Thomas Jefferson] node 310, connected by [Is A] edge 320 to entity type [U.S. President] node 304 and by [Is A] edge 322 to [Person] entity type node 324. Thus, knowledge graph portion 300 indicates that “Thomas Jefferson” has the entity types “U.S. President” and “Person.” In some implementations, [Thomas Jefferson] node 310 is connected to nodes not shown in FIG. 3 referencing his date of birth, gender, and assumed office date.

It will be understood that knowledge graph portion 300 is merely an example and that it may include nodes and edges not shown. For example, [U.S. President] node 304 may be connected to all of the U.S. Presidents. [U.S. President] node 304 may also be connected to properties related to the entity type such as a duration of term, for example [4 Years], a term limit, for example [2 Terms], a location of office, for example [Washington D.C.], any other suitable data, or any combination thereof. For example, [U.S. President] node 304 is connected to [Assumed Office Date] node 342 by [Has Property] edge 340, defining in part a schema for the type [U.S. President]. Similarly, [Thomas Jefferson] node 310 may be connected to any suitable number of nodes containing further information related to his illustrated entity type nodes [U.S. President], and [Person], and to other entity type nodes not shown such as [Inventor], [Vice President], and [Author]. In a further example, [Person] node 324 may be connected to all entities in the knowledge graph with the type [Person]. In a further example, [1789] node 328 may be connected to all events in the knowledge graph with the property of year [1789]. [1789] node 328 is unique to the year 1789, and disambiguated from, for example, a book entitled [1789], not shown in FIG. 3, by its unique identification reference. In some implementations, [1789] node 328 is connected to the entity type node [Year].

FIG. 4 shows illustrative knowledge graph portion 400 in accordance with some implementations of the present disclosure. Knowledge graph portion 400 includes [California] node 402, which may also be associated with differentiation aliases such as, for example, [CA], [Calif.], [Golden State], any other suitable differentiation aliases, or any combination thereof. In some implementations, these differentiations are stored in [California] node 402. California is connected by [Is A] edge 404 to the [U.S. State] entity type node 406. [New York] node 410 and [Texas] node 414 are also connected to [U.S. State] node 406 by [Is A] edges 408 and 412, respectively. [California] node 402 is connected by [Has Capital City] edge 420 to [Sacramento] node 422, indicating the information that “California Has Capital City Sacramento.” Sacramento node 422 is further connected by [Is A] edge 424 to the [City] entity type node 426. Similarly, [Texas] node 414 is connected by [Has City] edge 430 to [Houston] node 428, which is further connected to the [City] entity type node 426 by [Is A] edge 440. [California] node 402 is connected by [Has Population] edge 416 to node 418 containing the literal value [37,691,912]. In an example, the particular value [37,691,912] may be periodically automatically updated by the knowledge graph based on an external website or other source of data. Knowledge graph portion 400 may include other nodes not shown. For example, [U.S. State] entity type node 406 may be connected to nodes defining properties of that type such as [Population] and [Capital City]. These type-property relationships may be used to define other relationships in knowledge graph portion 400 such as [Has Population] edge 416 connecting entity node [California] 402 with terminal node 418 containing the literal defining the population of California.

It will be understood that while knowledge graph portion 300 of FIG. 3 and knowledge graph portion 400 of FIG. 4 below show portions of a knowledge graph, all pieces of information may be contained within a single graph and that these selections illustrated herein are merely an example. In some implementations, separate knowledge graphs are maintained for different respective domains, for different respective entity types, or according to any other suitable delimiting characteristic. In some implementations, separate knowledge graphs are maintained according to size constraints. In some implementations, a single knowledge graph is maintained for all entities and entity types.

A knowledge graph, or any other suitable data structure, may be implemented using any suitable software constructs. In an example, a knowledge graph is implemented using object oriented constructs in which each node is an object with associated functions and variables. Edges, in this context, may be objects having associated functions and variables. In some implementations, data contained in a knowledge graph, pointed to by nodes of a knowledge graph, or both, is stored in any suitable one or more data repositories across one or more servers located in one or more geographic locations coupled by any suitable network architecture.

FIG. 5 shows an illustrative first and second data source that may be merged using collective reconciliation in accordance with some implementations of the present disclosure. In some implementations, a collective reconciliation module, such as collective reconciliation module 122 of FIG. 1, implements the illustrated data merging. In the illustrated data sources, entity references are connected to attribute references in a data graph defined as nodes and edges such as those in data graph 200 of FIG. 2. As illustrated, the edges are not annotated. It will be understood that in some implementations, edges may be annotated, as shown in knowledge graph portion 300 of FIG. 3, and those annotations may be used by the collective reconciliation module in merging and/or removing duplicates.

Nodes in data source 502 are shown using solid outlines. Data source 502 includes entity reference 504 with the name “Dog” and the unique identifier /001/. “Dog” entity reference 504 is connected to attribute reference 506 containing the information “Color: Brown.” It will be understood that in some implementations, though not shown, attribute references may be assigned unique identifier references. In some implementations, the unique identifier reference is the name of the reference. In some implementations, the unique identifier reference is an alphanumeric string, as shown. “Dog” entity reference 504 is also connected to attribute reference 508 containing the information “Name: Buddy.” “Dog” Entity reference 504 is also connected to attribute reference 510, containing the information “Breed: Corgi.” Data source 502 also includes entity reference 554 with the name “Fish” and the unique identifier /006/. Thus, data source 502 may be understood to represent the information of a brown corgi dog named Buddy, and a fish.

Nodes in data source 512 are shown using dashed outlines. Data source 512 contains entity reference 514 with the name “Dog” and the unique identifier /002/, entity reference 520 with the name “Dog” and the unique identifier /003/, entity reference 524 with the name “Dog” and the unique identifier /004/, and entity reference 530 with the name “Cat” and the unique identifier /005/. “Dog” entity reference 514 is connected to attribute reference 516 containing the information “Name: Buddy,” and is connected to attribute reference 518 containing the information “Color: Brown.” Entity reference 520 is also connected to the attribute reference 518 containing the information “Color: Brown,” and is connected to attribute reference 522 containing the information “Breed: Poodle.” Entity reference 524 is connected to attribute reference 526 containing the information “Name: Spot” and is connected to attribute reference 528 containing the information “Breed: Corgi.” Thus, the data contained in data source 512 may represent the information that there is a brown dog named buddy, a brown poodle, a corgi named Spot, and a cat.

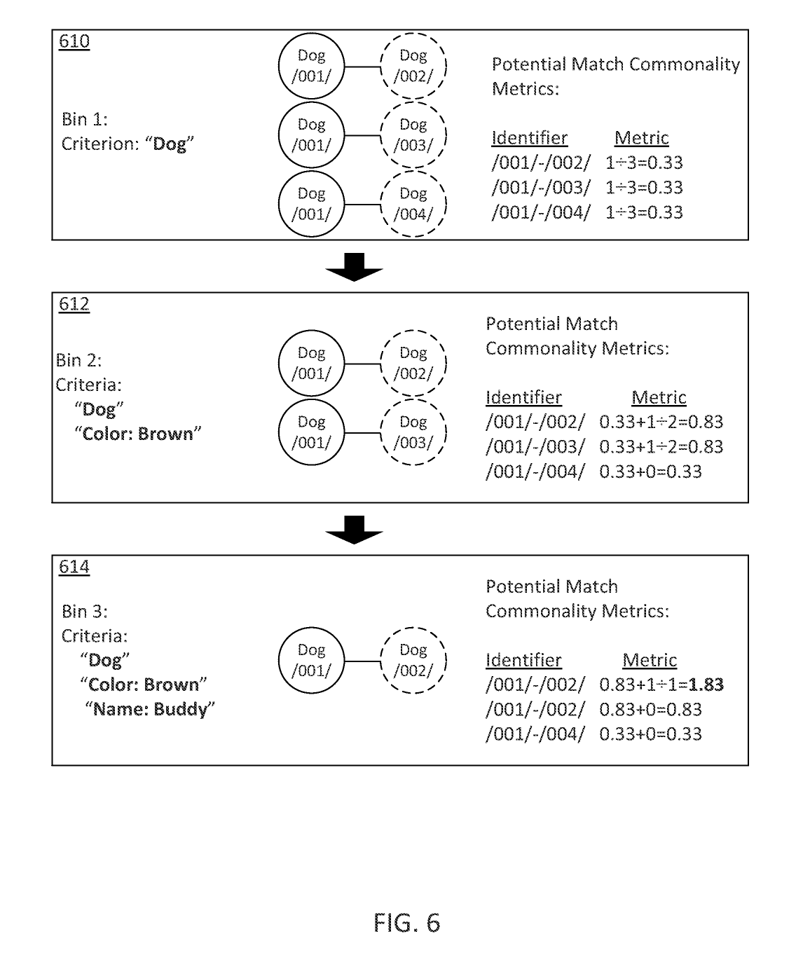

FIG. 6 shows an iterative binning process used in collective reconciliation in accordance with some implementations of the present disclosure. In some implementations, a collective reconciliation module performs iterative binning to merge data source 502 of FIG. 5 and data source 512 of FIG. 5. Entity references corresponding to data source 502 of FIG. 5 are shown as solid circles, while entity references corresponding to data source 512 of FIG. 5 are shown as dashed circles. The unique identifiers of the entity references correspond to the unique identifiers shown in FIG. 5. FIG. 6 shows three steps of an iterative binning process. It will be understood that any suitable number of steps may be used.

In an implementation of the first step of the binning process shown in block 610, the collective reconciliation module finds potential pairings between the first data source and the second data source. As illustrated, the collective reconciliation module finds that there is an entity reference with the name “Dog” in the first data source, and searches the second data source for entity references with the name “Dog” to identify potential pairings. Potential pairings are identified between entity reference /001/ with each of /002/, /003/, and /004/, as all have the name “Dog”. Thus, the criteria for the bin are that both nodes of the pairing have the name “Dog.” In block 610, a metric is calculated for each of the potential pairings. In the illustrated example, a total metric value of 1 is assigned for each step of the binning process. As illustrated, the value is divided evenly between those potential pairings that satisfy the criteria, that is to say, those that fit into the bin. The value 1 is divided by 3, because there are three potential pairings in the bin, and thus each of the /001/-/002/ pairing, the /001/-/003/ pairing, and the /001/-/004/ pairing is assigned a metric value of 0.33.

Block 612 shows the next step of an exemplary iterative binning process following the binning of shown in block 610. The criteria for Bin 2 include “Dog” and “Color: Brown.” In an embodiment, the criteria are determined based on attributes associated with entity reference 504 of FIG. 5. For example, the criteria for the binning step shown in block 610 includes the name of entity reference 504, and the criteria for the binning step shown in block 612 includes the name of entity reference 504 and associated attribute “Color: Brown” associated with attribute reference 506. In the illustrated example, two of the potential pairings shown in block 610 satisfy the criteria of block 612: the /001/-/002/ pairing and the /001/-/003/ pairing. As described above, a total metric value of 1 is assigned for each step of the binning process, divided evenly between those potential pairings that meet the criteria. As shown, the total value 1 is divided by 2, thus a value of 0.5 is added to the previous value for pairing, resulting in the /001/-/002/ pairing having a value 0.83, the /001/-/003/ pairing having a value 0.83, and the /001/-/004/ pairing, which did not meet the criteria, having a value of 0.33 as assigned previously in block 610.

Block 614 shows a subsequent step of an exemplary iterative binning process, following the binning of shown in block 612. The criteria for Bin 2 include “Dog”, “Color: Brown”, and “Name: Buddy.” In some implementations, these criteria are determined as described above for block 612. In the illustrated example, the /001/-/002/ pairing satisfies the criteria. The total value 1 is assigned to the /001/-/002/ pairing, resulting in the /001/-/002/ pairing being assigned a value 1.83, the /001/-/003/ pairing being assigned a value 0.83, and the /001/-/004/ being assigned a value 0.33.

In the illustrated example, the /001/-/002/ pairing has the highest metric value. The potential pairing may be identified having a commonality, and thus is identified as a duplicate based on a comparison of the metrics among the potential pairs, based on a comparison to a threshold, based on any other suitable criteria, or any combination thereof. In an example, a potential pairing is considered a duplicate if it has the highest metric after the end of the iterative binning process and has a metric above 1. Thus, the collective reconciliation module may identify a pairing as corresponding to a weak connection when it is the highest rated pairing in an iterative binning process, but the metric is below a threshold.

In block 614, the collective reconciliation module may identify that there is only one potential pairing meeting the criteria. In some implementations, the collective reconciliation module uses this as an indicator that the iterative binning process is complete. It will be understood that completion of the iterative binning process may be identified by any suitable indication. For example, indications may include when there are no pairs meeting the criteria, where there are a particular number of pairs meeting the criteria, when a particular number of criteria are used, when adding additional criteria does not reduce the number of pairs meeting the criteria, when the metric of a pairing reaches a particular level, any other suitable criteria, or any combination thereof. In some implementations, the aforementioned levels and values may be predetermined, determined based on user input, determined based on prior processing, determined based on design of the collective reconciliation module, determined based on the particular data being processed, determined based on the computer or computers being used, determined based on any other suitable criteria, or any combination thereof.

Referring back to FIG. 5, merged data source 532 shows merged source that in some implementations is the result of an iterative binning process identifying duplicates as illustrated in FIG. 6. In merged data source 532, entity references and attribute references from data source 502 are shown using a solid outline, entity references and attribute references from data source 512 are shown using a dashed outline, and merged entity references and attribute references that correspond to both the first and second data sources are shown using a dash-dot-dot outline.

In an example, the iterative binning process identifies that “Dog” entity reference /001/ 504 of data source 502 is a duplicate of “Dog” entity reference /002/ 514 of data source 512. The collective reconciliation module may generate a merged data source with the duplicates removed, as shown in merged data source 532. “Dog” entity reference 534 corresponds to the merged duplications of entity references 502 and 514. It will be understood that the collective reconciliation module may assign merged references a unique identifier assigned with the first data source, the second data source, a combination of the two data sources, a new and unrelated unique identifier, or any other suitable identifier. “Color: Brown” attribute reference 518 corresponds to both attribute reference 506 of data source 502 and attribute reference 518 of data source 512. “Name: Buddy” 536 corresponds to both attribute reference 508 of data source 502 and attribute reference 516 of data source 512. “Breed: Corgi” attribute reference 540 may correspond to attribute reference 510 of data source 502. In an example, the inclusion of attribute reference “Breed: Corgi” illustrates how a merged data source can combine overlapping attribute references associated with an entity reference. Merged data source 532 also includes “Dog” entity reference 542, “Breed: Poodle” attribute reference 544, “Dog” entity reference 546, “Name: Spot” entity reference 548, “Breed: Corgi” entity reference 550. Merged data source also includes “Cat” entity reference 552 corresponding to data source 512 and “Fish” entity reference 556 corresponding to entity reference 554.

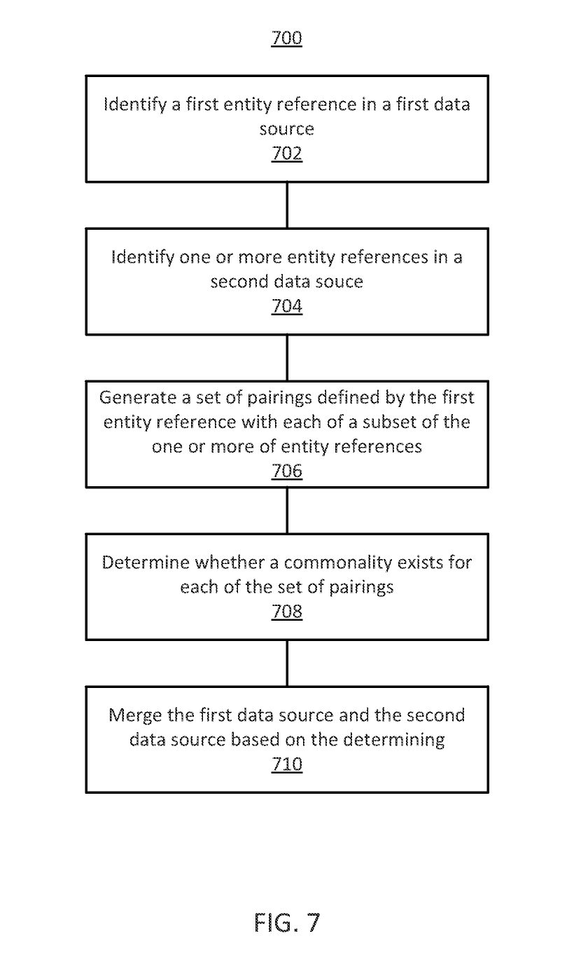

FIG. 7 shows flow diagram 700 including illustrative steps for merging data sources using collective reconciliation in accordance with some implementations of the present disclosure.

In step 702, the collective reconciliation module identifies a first entity reference in a first data source. In some implementations, a data source is defined as described for data graph 200 of FIG. 2. For example, a first data source may be data source 502 of FIG. 5. In the example illustrated above with reference to FIG. 5, a first entity reference with the identifier “Dog” was identified in the data source 502. In some implementations, a first entity reference may be any suitable piece of information in a data source. In an example, the first data source is composed of nodes representing entities, where those nodes are connected to other nodes by edges. The edges may define relationships between the nodes. In some implementations, the first entity reference may be associated with a name, attributes, unique identifiers, contextual information, metadata, any other suitable information, or any combination thereof. In some implementations, identifying the first entity reference includes traversing a data source, crawling between nodes of a data source, identifying an entity in response to user input, identifying an entity based on sequential or other predetermined instructions, randomly identifying a first entity reference from within a data source, any other suitable technique to identify a first entity reference, or any combination thereof. It will be understood that identifying a first entity reference in a first data source may include identifying more than one entity reference in the first data source.

In step 704, the collective reconciliation module identifies one or more entity references in a second data source. In some implementations, the second data source is defined using nodes and edges as described for the first data source in step 702. In an example, the second data source may be data source 512 of FIG. 5. In some implementations, identifying one or more entity references includes identifying entity references corresponding to the first entity reference identifying in step 702 based on an identifier match. In some implementations, an identifier match represents, for example, the first entity reference and the second entity reference having the same or similar same name, title, or other identifying information. In the example illustrated in reference to FIG. 5, a plurality of second references with the identifier “Dog” were identified in data source 512. It will be understood that the collective reconciliation module may identify any suitable number of entity references in the second data source. In some implementations, the relationship between the first entity reference in the first data source and each respective entity reference of the one or more entity references in the second data source represents a pairing, and thus is a potential duplicate entity reference in a merged data source.

It will be understood that the collective reconciliation module may merge two or more data sources using collective reconciliation. Merging may occur in any suitable order. For example, the collective reconciliation module may merge three data sources. In some implementations, the collective reconciliation module may only merge two data sources at a time to generate an intermediate merged data source, and then merge the intermediate merged data source with a third data source to generate a final merged data source. In some implementations, the collective reconciliation module may merge all three or more data sources simultaneously.

In step 706, the collective reconciliation module generates a set of pairings defined by the first entity reference with each of a subset of the one or more entity references based on an iterative analysis. In some implementations, the iterative analysis is referred to as collective reconciliation. In some implementations, the iterative analysis comprises increasing a number of common attributes used to define the set of pairings for each respective iteration. In some implementations, each subsequent iteration generates a reduced set of pairings.

The iterative binning process illustrated in FIG. 6 is an example of the collective reconciliation of step 706. In some implementations, the collective reconciliation module processes potential pairings as identified in step 704 using an iterative binning process to determine the strength of a relationship between entity references in a first data source and a second data source. In each step of the iterative binning process, the collective reconciliation module changes the criteria for the bin. In some implementations, the collective reconciliation module determines criteria based on attribute references associated with the first entity reference identified in step 702. In some implementations, the collective reconciliation module successively adds criteria, such that each iterative binning step includes more criteria than the previous step, and as a result contains fewer potential pairs of entities that satisfy those criteria. In some implementations, the collective reconciliation module removes or replaces criteria in successive iterative binning steps.

In some implementations, the collective reconciliation module determines a degree of commonality based on the entities in the second data source that correspond to the first entity, that is, the number of pairs in the bin. For example, a small number of pairs satisfying the criteria of a bin may be indicative of a high degree of commonality between those pairs. In some implementations, the degree of commonality is represented as a metric indicative of the strength of a relationship of a pairing.

In some implementations, the collective reconciliation module maintains a metric for each pairing identified in step 706. In an example, the collective reconciliation module increases the metric for a pairing by 1, or any other suitable value, if the pairing satisfies the criteria of that bin in the iterative process. In another example, as illustrated in FIG. 6, the collective reconciliation module divides a particular amount of metric value among the pairs that satisfy the binning criteria, such that the maintained metric increases more rapidly for a bin containing less pairs. In another example, the amount of metric applied and/or divided by the collective reconciliation module among pairings increases or decreases with iterative binning step. It will be understood that the aforementioned metric determinations are merely exemplary and that any suitable technique to determine and maintain a metric may be used.

In step 708, the collective reconciliation module determines whether a commonality exists for each of the set of pairings. In some implementations, determining whether a commonality exists for each of the set of pairings includes determining that the pairing includes two entity references that reference the same entity. For example, in a merged data source, the entity references of a pairing may represent duplicated data.

In some implementations, the collective reconciliation module determines whether a commonality, and thus a duplication, exists based on a metric. For example, metrics may include the commonality metrics calculated for each of the potential pairings in the iterative binning process illustrated in FIG. 6 above. In some implementations, the collective reconciliation module determines if a paring represents a commonality by comparing the metric to a threshold, comparing the metric to the metrics for other pairings, comparing a metric to any other suitable criteria, or any combination thereof. In an example, the collective reconciliation module identifies the highest valued metric in a set of pairings, such as the set shown in block 610 of FIG. 6, as a commonality. In another example, the collective reconciliation module compares the highest metric of a set of pairings to a threshold, to determine if the pairing represents a commonality. In the example of FIG. 6, if the threshold was 1, the collective reconciliation module would identify the pair /001/-/002/ as a commonality in block 614 of FIG. 6. The collective reconciliation module determines a threshold based on user input, collective reconciliation module design, machine learning based on previous processing, the particular category and/or type of data, any other suitable criteria, or any combination thereof. In another example, the collective reconciliation module uses a relative comparison of the metric to other data to determine if a particular pairing is indicative of a statistically significant strength of commonality as compared to, for example, other evaluated pairings.

In step 710, the collective reconciliation module merges the first data source and the second data source, wherein duplications are identified based on the determining of a commonality in step 708. In the example illustrated in FIG. 5 and FIG. 6, the collective reconciliation module generates merged data source 532 of FIG. 5 in step 710. In some implementations, a merged data source includes the data from all of the two or more data sources, with duplicate entity references removed. In some implementations, a merged data source includes data from multiple data sources with the duplicate entries identified as duplicates. For example, both entity references may be included in the merged data set, with one or both identified as a duplication. It will be understood that the collective reconciliation module may merged a first data source and a second data source where no commonalities are identified, and thus no duplications are removed. In some implementations, the merged data source includes a union of the data sources, the intersection of the data sources, the set difference of the data sources, the symmetric difference of the data sources, any other suitable merged data source, or any combination thereof. In an example, the collective reconciliation module produces more than one merged data source, such as a set with the duplicates removed and a set of the duplicated entries.

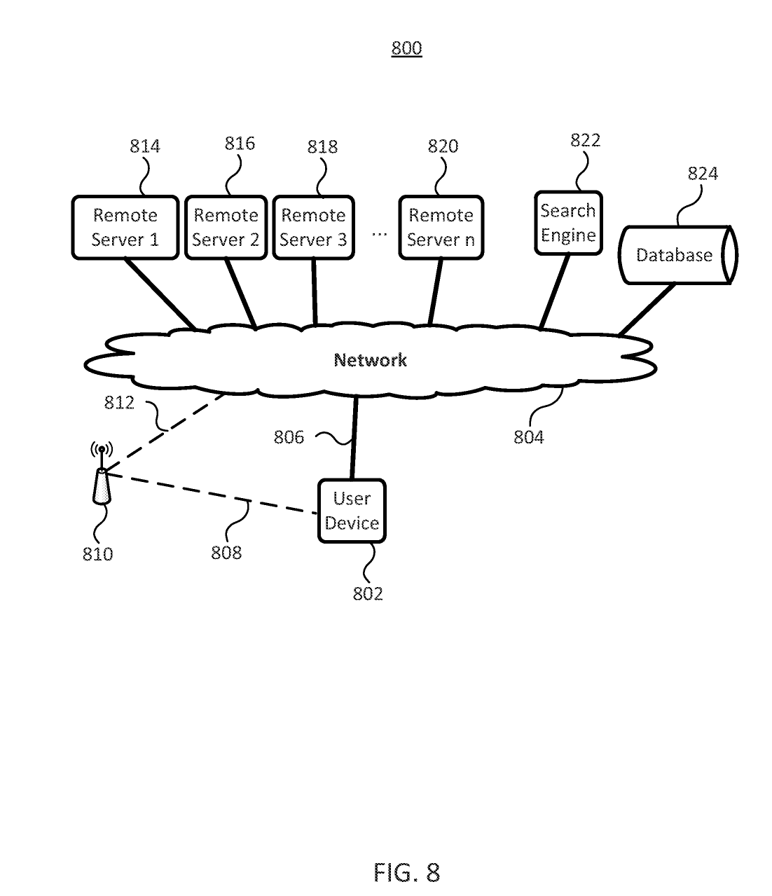

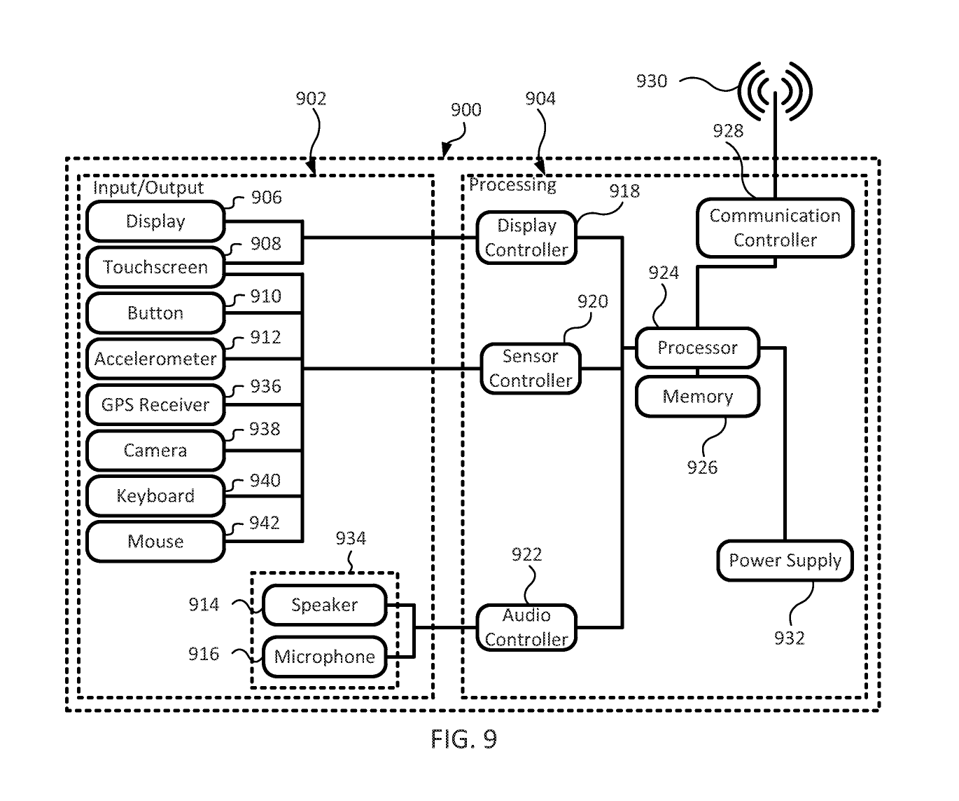

The following description and accompanying FIGS. 8 and 9 describe illustrative computer systems that may be used in some implementations of the present disclosure. It will be understood that elements of FIGS. 8 and 9 are merely exemplary and that any suitable elements may be added, removed, duplicated, replaced, or otherwise modified.

It will be understood that the collective reconciliation module may be implemented on any suitable computer or combination of computers, including those illustrated in FIGS. 8 and 9. In some implementations, the collective reconciliation module is implemented in a distributed computer system including two or more computers. In an example, the collective reconciliation module may use a cluster of computers located in one or more locations to perform processing and storage associated with the collective reconciliation module. It will be understood that distributed computing may include any suitable parallel computing, distributed computing, network hardware, network software, centralized control, decentralized control, any other suitable implementations, or any combination thereof.

FIG. 8 shows an illustrative computer system that may be used to implement collective reconciliation in accordance with some implementations of the present disclosure. System 800 may include one or more user device 802. In some implementations, user device 802, and any other device of system 800, includes one or more computers and/or one or more processors. In some implementations, a processor includes one or more hardware processors, for example, integrated circuits, one or more software modules, computer-readable media such as memory, firmware, or any combination thereof. In some implementations, user device 802 includes one or more computer-readable medium storing software, include instructions for execution by the one or more processors for performing the techniques discussed above with respect to flow diagram 700 of FIG. 7 and/or any other techniques disclosed herein. In some implementations, user device 802 may include a smartphone, tablet computer, desktop computer, laptop computer, personal digital assistant or PDA, portable audio player, portable video player, mobile gaming device, other suitable user device capable of providing content, or any combination thereof.

User device 802 may be coupled to network 804 directly through connection 806, through wireless repeater 810, by any other suitable way of coupling to network 804, or by any combination thereof. Network 804 may include the Internet, a dispersed network of computers and servers, a local network, a public intranet, a private intranet, other coupled computing systems, or any combination thereof.

user device 802 may be coupled to network 804 by wired connection 806. Connection 806 may include Ethernet hardware, coaxial cable hardware, DSL hardware, T-1 hardware, fiber optic hardware, analog phone line hardware, any other suitable wired hardware capable of communicating, or any combination thereof. Connection 806 may include transmission techniques including TCP/IP transmission techniques, IEEE 902 transmission techniques, Ethernet transmission techniques, DSL transmission techniques, fiber optic transmission techniques, ITU-T transmission techniques, any other suitable transmission techniques, or any combination thereof.

user device 802 may be wirelessly coupled to network 804 by wireless connection 808. In some implementations, wireless repeater 810 receives transmitted information from local computer 802 by wireless connection 808 and communicates it with network 804 by connection 812. Wireless repeater 810 receives information from network 804 by connection 812 and communicates it with user device 802 by wireless connection 808. In some implementations, wireless connection 808 may include cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Connection 812 may include Ethernet hardware, coaxial cable hardware, DSL hardware, T-1 hardware, fiber optic hardware, analog phone line hardware, wireless hardware, any other suitable hardware capable of communicating, or any combination thereof. Connection 812 may include wired transmission techniques including TCP/IP transmission techniques, IEEE 902 transmission techniques, Ethernet transmission techniques, DSL transmission techniques, fiber optic transmission techniques, ITU-T transmission techniques, any other suitable transmission techniques, or any combination thereof. Connection 812 may include may include wireless transmission techniques including cellular phone transmission techniques, code division multiple access or CDMA transmission techniques, global system for mobile communications or GSM transmission techniques, general packet radio service or GPRS transmission techniques, satellite transmission techniques, infrared transmission techniques, Bluetooth transmission techniques, Wi-Fi transmission techniques, WiMax transmission techniques, any other suitable transmission techniques, or any combination thereof.

Wireless repeater 810 may include any number of cellular phone transceivers, network routers, network switches, communication satellites, other devices for communicating information from user device 802 to network 804, or any combination thereof. It will be understood that the arrangement of connection 806, wireless connection 808 and connection 812 is merely illustrative and that system 800 may include any suitable number of any suitable devices coupling user device 802 to network 804. It will also be understood that any user device 802, may be communicatively coupled with any user device, remote server, local server, any other suitable processing equipment, or any combination thereof, and may be coupled using any suitable technique as described above.

In some implementations, any suitable number of remote servers 814, 816, 818 and 820, may be coupled to network 804. Remote servers may be general purpose, specific, or any combination thereof. In some implementations, any suitable number of remote servers 814, 816, 818, and 820 may be elements of a distributed computing network. One or more search engine servers 822 may be coupled to the network 804. In some implementations, search engine server 822 may include the data graph, may include processing equipment configured to access the data graph, may include processing equipment configured to receive search queries related to the data graph, may include any other suitable information or equipment, or any combination thereof. One or more database servers 824 may be coupled to network 804. In some implementations, database server 824 may store the data graph. In some implementations, where there is more than one data graph, the more than one may be included in database server 824, may be distributed across any suitable number of database servers and general purpose servers by any suitable technique, or any combination thereof. It will also be understood that the collective reconciliation module may use any suitable number of general purpose, specific purpose, storage, processing, search, any other suitable server, or any combination.

FIG. 9 is a block diagram of a computer of the illustrative computer system of FIG. 8 in accordance with some implementations of the present disclosure. In some implementations, computer 900 is an illustrative user device, local computer, remote computer, element of a distributed computing system, any other suitable computing device, or any combination thereof. Computer 900 may include input/output equipment 902 and processing equipment 904. Input/output equipment 902 may include display 906, touchscreen 908, button 910, accelerometer 912, global positions system or GPS receiver 936, camera 938, keyboard 940, mouse 942, and audio equipment 934 including speaker 914 and microphone 916. In some implementations, the equipment illustrated in FIG. 9 may be representative of equipment included in a user device such as a smartphone, laptop, desktop, tablet, or other suitable user device. It will be understood that the specific equipment included in the illustrative computer system may depend on the type of user device. For example, the Input/output equipment 902 of a desktop computer may include a keyboard 940 and mouse 942 and may omit accelerometer 912 and GPS receiver 936. It will be understood that computer 900 may omit any suitable illustrated elements, and may include equipment not shown such as media drives, data storage, communication devices, display devices, processing equipment, any other suitable equipment, or any combination thereof.

In some implementations, display 906 may include a liquid crystal display, light emitting diode display, organic light emitting diode display, amorphous organic light emitting diode display, plasma display, cathode ray tube display, projector display, any other suitable type of display capable of displaying content, or any combination thereof. Display 906 may be controlled by display controller 918 or by processor 924 in processing equipment 904, by processing equipment internal to display 906, by other controlling equipment, or by any combination thereof. In some implementations, display 906 may display data from a data graph.

Touchscreen 908 may include a sensor capable of sensing pressure input, capacitance input, resistance input, piezoelectric input, optical input, acoustic input, any other suitable input, or any combination thereof. Touchscreen 908 may be capable of receiving touch-based gestures. Received gestures may include information relating to one or more locations on the surface of touchscreen 908, pressure of the gesture, speed of the gesture, duration of the gesture, direction of paths traced on its surface by the gesture, motion of the device in relation to the gesture, other suitable information regarding a gesture, or any combination thereof. In some implementations, touchscreen 908 may be optically transparent and located above or below display 906. Touchscreen 908 may be coupled to and controlled by display controller 918, sensor controller 920, processor 924, any other suitable controller, or any combination thereof. In some implementations, touchscreen 908 may include a virtual keyboard capable of receiving, for example, a search query used to identify data in a data graph.

In some implementations, a gesture received by touchscreen 908 may cause a corresponding display element to be displayed substantially concurrently, for example, immediately following or with a short delay, by display 906. For example, when the gesture is a movement of a finger or stylus along the surface of touchscreen 908, the collective reconciliation module may cause a visible line of any suitable thickness, color, or pattern indicating the path of the gesture to be displayed on display 906. In some implementations, for example, a desktop computer using a mouse, the functions of the touchscreen may be fully or partially replaced using a mouse pointer displayed on the display screen.

Button 910 may be one or more electromechanical push-button mechanism, slide mechanism, switch mechanism, rocker mechanism, toggle mechanism, other suitable mechanism, or any combination thereof. Button 910 may be included in touchscreen 908 as a predefined region of the touchscreen, e.g. soft keys. Button 910 may be included in touchscreen 908 as a region of the touchscreen defined by the collective reconciliation module and indicated by display 906. Activation of button 910 may send a signal to sensor controller 920, processor 924, display controller 920, any other suitable processing equipment, or any combination thereof. Activation of button 910 may include receiving from the user a pushing gesture, sliding gesture, touching gesture, pressing gesture, time-based gesture, e.g. based on the duration of a push, any other suitable gesture, or any combination thereof.

Accelerometer 912 may be capable of receiving information about the motion characteristics, acceleration characteristics, orientation characteristics, inclination characteristics and other suitable characteristics, or any combination thereof, of computer 900. Accelerometer 912 may be a mechanical device, microelectromechanical or MEMS device, nanoelectromechanical or NEMS device, solid state device, any other suitable sensing device, or any combination thereof. In some implementations, accelerometer 912 may be a 3-axis piezoelectric microelectromechanical integrated circuit which is configured to sense acceleration, orientation, or other suitable characteristics by sensing a change in the capacitance of an internal structure. Accelerometer 912 may be coupled to touchscreen 908 such that information received by accelerometer 912 with respect to a gesture is used at least in part by processing equipment 904 to interpret the gesture.

Global positioning system or GPS receiver 936 may be capable of receiving signals from global positioning satellites. In some implementations, GPS receiver 936 may receive information from one or more satellites orbiting the earth, the information including time, orbit, and other information related to the satellite. This information may be used to calculate the location of computer 900 on the surface of the earth. GPS receiver 936 may include a barometer, not shown, to improve the accuracy of the location. GPS receiver 936 may receive information from other wired and wireless communication sources regarding the location of computer 900. For example, the identity and location of nearby cellular phone towers may be used in place of, or in addition to, GPS data to determine the location of computer 900.

Camera 938 may include one or more sensors to detect light. In some implementations, camera 938 may receive video images, still images, or both. Camera 938 may include a charged coupled device or CCD sensor, a complementary metal oxide semiconductor or CMOS sensor, a photocell sensor, an IR sensor, any other suitable sensor, or any combination thereof. In some implementations, camera 938 may include a device capable of generating light to illuminate a subject, for example, an LED light. Camera 938 may communicate information captured by the one or more sensor to sensor controller 920, to processor 924, to any other suitable equipment, or any combination thereof. Camera 938 may include lenses, filters, and other suitable optical equipment. It will be understood that computer 900 may include any suitable number of camera 938.

Audio equipment 934 may include sensors and processing equipment for receiving and transmitting information using acoustic or pressure waves. Speaker 914 may include equipment to produce acoustic waves in response to a signal. In some implementations, speaker 914 may include an electroacoustic transducer wherein an electromagnet is coupled to a diaphragm to produce acoustic waves in response to an electrical signal. Microphone 916 may include electroacoustic equipment to convert acoustic signals into electrical signals. In some implementations, a condenser-type microphone may use a diaphragm as a portion of a capacitor such that acoustic waves induce a capacitance change in the device, which may be used as an input signal by computer 900.

Speaker 914 and microphone 916 may be contained within computer 900, may be remote devices coupled to computer 900 by any suitable wired or wireless connection, or any combination thereof.

Speaker 914 and microphone 916 of audio equipment 934 may be coupled to audio controller 922 in processing equipment 904. This controller may send and receive signals from audio equipment 934 and perform pre-processing and filtering steps before transmitting signals related to the input signals to processor 924. Speaker 914 and microphone 916 may be coupled directly to processor 924. Connections from audio equipment 934 to processing equipment 904 may be wired, wireless, other suitable arrangements for communicating information, or any combination thereof.

Processing equipment 904 of computer 900 may include display controller 918, sensor controller 920, audio controller 922, processor 924, memory 926, communication controller 928, and power supply 932.

Processor 924 may include circuitry to interpret signals input to computer 900 from, for example, touchscreen 908 and microphone 916. Processor 924 may include circuitry to control the output to display 906 and speaker 914. Processor 924 may include circuitry to carry out instructions of a computer program. In some implementations, processor 924 may be an integrated electronic circuit based, capable of carrying out the instructions of a computer program and include a plurality of inputs and outputs.

Processor 924 may be coupled to memory 926. Memory 926 may include random access memory or RAM, flash memory, programmable read only memory or PROM, erasable programmable read only memory or EPROM, magnetic hard disk drives, magnetic tape cassettes, magnetic floppy disks optical CD-ROM discs, CD-R discs, CD-RW discs, DVD discs, DVD+R discs, DVD-R discs, any other suitable storage medium, or any combination thereof.

The functions of display controller 918, sensor controller 920, and audio controller 922, as have been described above, may be fully or partially implemented as discrete components in computer 900, fully or partially integrated into processor 924, combined in part or in full into combined control units, or any combination thereof.

Communication controller 928 may be coupled to processor 924 of computer 900. In some implementations, communication controller 928 may communicate radio frequency signals using antenna 930. In some implementations, communication controller 928 may communicate signals using a wired connection, not shown. Wired and wireless communications communicated by communication controller 928 may use Ethernet, amplitude modulation, frequency modulation, bitstream, code division multiple access or CDMA, global system for mobile communications or GSM, general packet radio service or GPRS, satellite, infrared, Bluetooth, Wi-Fi, WiMax, any other suitable communication configuration, or any combination thereof. The functions of communication controller 928 may be fully or partially implemented as a discrete component in computer 900, may be fully or partially included in processor 924, or any combination thereof. In some implementations, communication controller 928 may communicate with a network such as network 804 of FIG. 8 and may receive information from a data graph stored, for example, in database 824 of FIG. 8.

Power supply 932 may be coupled to processor 924 and to other components of computer 900. Power supply 932 may include a lithium-polymer battery, lithium-ion battery, NiMH battery, alkaline battery, lead-acid battery, fuel cell, solar panel, thermoelectric generator, any other suitable power source, or any combination thereof. Power supply 932 may include a hard wired connection to an electrical power source, and may include electrical equipment to convert the voltage, frequency, and phase of the electrical power source input to suitable power for computer 900. In some implementations of power supply 932, a wall outlet may provide 120 volts, 60 Hz alternating current or AC. A circuit of transformers, resistors, inductors, capacitors, transistors, and other suitable electronic components included in power supply 932 may convert the 120V alternating current at 60 Hz from a wall outlet power to 5 volts of direct current at 0 Hz. In some implementations of power supply 932, a lithium-ion battery including a lithium metal oxide-based cathode and graphite-based anode may supply 3.7V to the components of computer 900. Power supply 932 may be fully or partially integrated into computer 900, or may function as a stand-alone device. Power supply 932 may power computer 900 directly, may power computer 900 by charging a battery, may provide power by any other suitable way, or any combination thereof.

The foregoing is merely illustrative of the principles of this disclosure and various modifications may be made by those skilled in the art without departing from the scope of this disclosure. The above described implementations are presented for purposes of illustration and not of limitation. The present disclosure also may take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

1. A computer-implemented method for merging electronic data sources, the method performed by at least one hardware processor and comprising:
identifying a first entity reference in a first electronic data source, the first electronic data source comprising nodes representing entities and comprising edges that define relationships between the nodes;
identifying one or more entity references in a second electronic data source, the second electronic data source comprising nodes representing entities and edges that define relationships between the nodes, wherein the one or more entity references correspond to the first entity reference based on an identifier match;
generating a set of pairings defined by the first entity reference with each of a subset of the one or more entity references;
performing an iterative analysis on the generated set of pairings, the iterative analysis comprising:
increasing a number of common attributes used to define the set of pairings for each respective iteration,
generating a reduced set of pairings for each respective iteration based on the increase in the number of common attributes,
assigning commonality metrics to each pairing from the reduced set of parings in each respective iteration, and
aggregating the assigned commonality metrics from each iteration for each pairing;
determining whether a commonality exists for each pairing remaining after the iterative analysis based on the aggregated commonality metrics; and
merging the first electronic data source and the second electronic data source, wherein duplications are identified based at least in part on the determination.

2. The method of claim 1, wherein generating the set of pairings comprises determining a degree of commonality based on a number of entities in the second electronic data source that correspond to the first entity based on the identifier match.

3. (canceled)

4. The method of claim 1, wherein assigning commonality metrics to each paring in the reduced set of parings in each respective iteration includes increasing or decreasing a metric for at least one pairing based on a number of parings in the reduced set.

5. (canceled)

6. The method of claim 1, wherein the merging comprises removing duplications from the merged data.

7. The method of claim 1, wherein identifying the first entity reference includes identifying the first entity reference by crawling between the nodes of the first electronic data source.

8. The method of claim 1, wherein the identifier match represents the first entity and the second entity having the same or similar name.

9. A system for merging electronic data sources, comprising:
one or more hardware processors configured to perform operations comprising:
identifying a first entity reference in a first electronic data source, the first electronic data source comprising nodes representing entities and comprising edges that define relationships between the nodes;
identifying one or more entity references in a second electronic data source, the second electronic data source comprising nodes representing entities and edges that define relationships between the nodes, wherein the one or more entity references correspond to the first entity reference based on an identifier match;
generating a set of pairings defined by the first entity reference with each of a subset of the one or more entity references;
performing an iterative analysis on the generated set of pairings, the iterative analysis comprising:
increasing a number of common attributes used to define the set of pairings for each respective iteration,
generating a reduced set of pairings for each respective iteration based on the increase in the number of common attributes;
assigning commonality metrics to each paring from the reduced set of parings in each respective iteration, and
aggregating the assigned commonality metrics from each iteration for each pairing;
determining whether a commonality exists for each pairing remaining after the iterative analysis based on the aggregated commonality metrics; and
merging the first electronic data source and the second electronic data source, wherein duplications are identified based at least in part on the determination.

10. The system of claim 9, wherein generating the set of pairings comprises determining a degree of commonality based on a number of entities in the second electronic data source that correspond to the first entity based on the identifier match.

11. (canceled)

12. The system of claim 9, wherein assigning calculated commonality metrics to each paring in the reduced set of parings in each respective iteration includes increasing or decreasing a metric for at least one pairing based on a number of parings in the set.

13. (canceled)

14. The system of claim 9, wherein the merging comprises removing duplications from the merged data.

15. The system of claim 9, wherein identifying the first entity reference includes identifying the first entity reference by crawling between the nodes of the first electronic data source.

16. The system of claim 9, wherein the identifier match represents the first entity and the second entity having the same or similar name.

17. A non-transitory computer-readable medium storing instructions that, when executed by one or more processors, cause the one or more processors to perform operations comprising:
identifying a first entity reference in a first electronic data source, the first electronic data source comprising nodes representing entities and comprising edges that define relationships between the nodes;
identifying one or more entity references in a second electronic data source, the second electronic data source comprising nodes representing entities and edges that define relationships between the nodes, wherein the one or more entity references correspond to the first entity reference based on an identifier match;
generating a set of pairings defined by the first entity reference with each of a subset of the one or more entity references;
performing an iterative analysis on the generated set of pairings, the iterative analysis comprising:
increasing a number of common attributes used to define the set of pairings for each respective iteration,
generating a reduced set of pairings for each respective iteration based on the increase in the number of common attributes,
assigning commonality metrics to each paring from the reduced set of pairings in each respective iteration, and
aggregating the assigned commonality metrics from each iteration for each pairing;
determining whether a commonality exists for each pairing remaining after the iterative analysis based on the aggregated commonality metrics; and
merging the first electronic data source and the second electronic data source, wherein duplications are identified based at least in part on the determination.

18. The computer-readable medium of claim 17, wherein generating the set of pairings comprises determining a degree of commonality based on a number of entities in the second electronic data source that correspond to the first entity based on the identifier match.

19. (canceled)

20. The computer-readable medium of claim 17, wherein assigning calculated commonality metrics to each paring in the reduced set of parings in each respective iteration includes increasing or decreasing a metric for at least one pairing of the set of pairings based on a number of parings in the set of pairings.

21. (canceled)

22. The computer-readable medium of claim 17, wherein the merging comprises removing duplications from the merged data.

23. The computer-readable medium of claim 17, wherein identifying the first entity reference includes identifying the first entity reference by crawlin. between the nodes of the first electronic data source.

24. The computer-readable medium of claim 17, wherein the identifier match represents the first entity and the second entity having the same or similar name.
